(19) United States
(12) Patent Application Publication
(10) Pub. No.: US 2009/0058072 A1
(43) Pub. Date: Mar. 5, 2009

(54) Record sheets with integrated themes

(76) Inventors: Shirlee Ann Weber, Neenah, WI (US); Andrew Mark Long, Appleton, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/897,645

(22) Filed: Aug. 30, 2007

(51) Int. Cl. B42D 15/00

(52) U.S. Cl. 283/48.1; 604/361

(57) ABSTRACT

A recording tool is provided for tracking absorbent article use, the tool including an ordinal number for each absorbent article for a given day; associated with each absorbent article, a non-alphanumeric health condition graphical representation of whether the absorbent article indicates the health condition, wherein the health condition graphical representation is thematically related to the health condition; and associated with the given day, a health condition assessment summarizing the absorbent articles indicating the health condition, wherein the health condition can be wetness. The recording tool can also include, associated with each absorbent article, a fecal content graphical representation of whether the absorbent article includes fecal content, wherein the fecal content graphical representation is thematically related to the fecal content.

### BACKGROUND

This disclosure relates to tools for tracking certain outputs of individuals who use absorbent products. Such tracking can aid the individual or a caregiver in determining, for example, the existence or progress of certain health conditions or the adequacy of breast feeding.

Mothers of newborn babies have a strong need to know how much breast milk their baby has consumed. There were 4.1 million births in the United States alone in 2003 and about 70% of all new moms breast feed. The first two weeks of breast feeding show the largest declines in breast feeding with 10% drop off each week. There is a significant opportunity to reassure mothers (especially first-time mothers) that their babies are breast feeding appropriately, particularly during the first weeks when mom is unsure and not confident in her breast feeding ability. The mother does not know the state of her baby's fluid intake and may question her baby's level of hydration.

Prior attempts to track breast feeding include devices that have attempted to quantify breast feeding by interposing a flow meter between mother and baby, and complicated recordkeeping sheets that attempt to track baby outputs. Such attempts can lead to obvious problems with delivery, intimacy, and bonding between mother and baby, and may be difficult to understand and use, especially by an inexperienced or sleep-deprived mother.

It is desired that mothers, individuals, and caregivers have a simple way to relate to their doctors or others regarding the condition of their child or patient. For example, some moms currently are sent home with record sheets to tell their doctor how many wet diapers and bowel movements their child has had. Such sheets are only given to some moms (many mothers receive nothing with which to record breastfeeding and need to improvise their own record sheet). Such sheets are also cumbersome and difficult to decipher.

In another example, many health conditions may be indicated, diagnosed, or monitored through the analysis of certain bodily fluid outputs, such as through urinalysis. Many devices and tools exist to perform such analyses in an absorbent product, but the results of such analyses can be difficult to track, particularly if a caregiver has multiple patients, if such analyses are performed outside of a clinical setting, if the recordkeeping is to be done in a language foreign to the caregiver or individual, or if the individual using such products is incapacitated in some respect.

### SUMMARY

In one aspect, the tools described herein may be an integral part of reassuring a nursing mother that her baby is receiving sufficient breast milk and therefore sufficient nutrition. The tools use objective recordkeeping indicative of the amount of breast milk swallowed by the baby. In another aspect, the tools described herein may be an integral part of reassuring a caregiver or an individual that the individual is receiving sufficient health care with respect to a potential or actual health condition.

Caregivers and individuals can be provided with reassurance and a sense of security by providing safe, comfortable, easy ways for a caregiver to track progress. Giving a mother a tool to help evaluate whether her baby is getting enough breast milk will help reassure the mother with respect to how well breast feeding is going and provide her with a sense of security regarding her baby's health. Giving a caregiver or an individual a tool to help evaluate whether the individual has a health condition or is making progress with respect to a health condition will help reassure the caregiver and the individual with respect to the health condition and provide the caregiver or the individual with a sense of security regarding the individual's health. Making such tools significantly easier results in increased compliance by caregivers and individuals.

In one aspect of the present disclosure, tools used for recordkeeping can be much improved by relating the theme of an indicator with that on a record sheet. For example, an absorbent article for which wetness is the desired indicator may be represented by water droplets on the record sheet. Such tools fulfill both the desires of caregivers and individuals for simple yet effective tools and the desires of medical personnel for increased compliance.

### BRIEF DESCRIPTION OF THE DRAWINGS

The foregoing and other features and aspects of the present disclosure and the manner of attaining them will become more apparent, and the disclosure itself will be better understood by reference to the following description, appended claims and accompanying drawings.

FIG. 1 is a schematic view of one aspect of the tool described herein;

FIG. 2 is a schematic view of one aspect of an absorbent article used with the tool of FIG. 1;

FIG. 3 is a schematic view of another aspect of an absorbent article used with the tool of FIG. 1;

FIG. 4 is a schematic view of another aspect of the tool described herein.

FIG. 5 is a schematic view of one aspect of an absorbent article used with the tool of FIG. 4; and

FIG. 6 is a schematic view of one aspect of an absorbent article used with the tool of FIG. 4.

Repeat use of reference characters in the present specification and drawings is intended to represent the same or analogous features or elements of the present disclosure.

### DETAILED DESCRIPTION

It is to be understood by one of ordinary skill in the art that the present discussion is a description of exemplary aspects only, and is not intended as limiting the broader aspects of the present disclosure.

The present disclosure is generally directed for use with absorbent articles that might be adapted to indicate a health condition of the user of the absorbent article. A health condition as used herein is the presence of a body fluid in the absorbent article. Health condition also includes the status of or changes in the condition of the product or wearer as indicated directly or indirectly by the presence or level of a body fluid or the presence or level of a constituent of a body fluid. In various examples, the presence of urine or menstrual fluid in an absorbent article indicates that the absorbent article is wet, which is considered a health condition herein. The presence or level of a certain chemical, analyte, or other constituent within that urine or menstrual fluid may indicate the existence of a different health condition.

Health conditions that may be indicated through the use of an absorbent article can include:
inferring the volume of breastfeeding from absorbent article wetness and fecal content
detecting the onset of infection or the status of an infection for a recovering patient;
monitoring the health of fetus or mother during pregnancy (pregnancy management), detecting such things as premature delivery by monitoring uterine contractions, antiphospholipid antibodies, fetal fibronectin proteins, and so forth;
monitoring reproductive status (e.g., onset of ovulation or other factors associated with fertility);
other hormone detection (e.g., growth factors, thyroid, menopause-related ones, etc.)
detecting the onset of menstruation;
monitoring analytes associated with renal disease, including analytes in the blood or urine measured before, during, or after dialysis, and analytes measured in any body fluids at home or for patients not receiving dialysis,
monitoring risk factors for osteoporosis, or the onset or status of the disease, or hormone levels or other agents correlated with the development or treatment of osteoporosis and other bone pathologies, through means such as monitoring bone-specific alkaline phosphatase or calcitonin;
monitoring factors related to heart disease, including analytes such as myoglobin, troponins, homocysteine, creatine kinase, thrombus precursor protein, fatty acid binding protein, CRP, and the like;
monitoring factors related to rheumatoid arthritis, including MMP-3, fibrin degradation products, anti-type II collagen, and collagen cross-linked N-telopeptides;
detecting factors related to stroke, including D-dimer in the blood or other body fluids;
monitoring the effectiveness or presence of a pharmaceutical agent such as an antibiotic;
detecting an enzyme or other factor associated with heart disease to alert a patient and/or caregivers of a potential cardiovascular problem;
identifying rheumatoid arthritis by detecting type I collagen crosslinked N-telopeptides in urine;
monitoring cyanosis or circulatory disorders in newborns, diabetics, and so forth;
monitoring the onset of a sleep apnea episode, coupled with treatments to enhance sleep when needed;
optically monitoring nail beds as a tool for assessing blood condition (for some tests, nails can be more transparent than skin to changes such as bluing);
tracking body position in a bed and applied pressure against the skin of the patient to prevent or care for bedsores (decubitus ulcers) and other ulcers or wounds; biosensors indicative of wound health and protein-degrading enzymes can also be employed in cooperative association with pressure and position sensors for this purpose;
tracking indicators of health by monitoring body odors or analytes in the gas phase near the body, using electronic nose technology or other sensors;
tracking stress with cortisol measurement in saliva or seratonin measurement, including establishing moving baselines to distinguish between acute stress and chronic stress, and optionally relating the time history of measured stress-related analytes to factors that may have induced the stress;
using archived time histories of one or more analytes as a record for identification of sudden changes in the treatment of a subject that may be traceable to changes in personnel, medication, and the like, wherein the time history may serve as a tool in detecting malpractice or other problems, or in verifying (or refuting) claims made by the user regarding health status of the subject;
detecting allergies using, as analytes, any of IgE (immunoglobulin E), eosinophilic cationic protein, cytokines such as IL-4 or IL-5 in mucous or in the blood or other body fluids, including the use of facial tissue equipped with biosensors for such analytes or with biosensors for bacteria or virus infection;
detecting bacterial infections using analytes such as cytokines (e.g., IL-6), C-reactive protein, calcitonin or pro-calcitonin, CD11b, ESBL enzymes (particularly for drug-resistant bacteria), and lipocalins;
detecting risk factors for cervical cancer by monitoring nuclear matrix protein (NMP) 179 or human papilloma virus from a pap smear;
monitoring levels of taurine in the body or in a local region, including monitoring taurine levels in a non-human mammal such as a domestic cat;
urinary tract infection testing;
yeast infection, bacterial infection, or other forms of vaginitis, including pH imbalance;
UV exposure detection;
nutritional monitoring or detection of nutrient levels, also including hydration monitoring, cholesterol testing, energy assessment, and anemia assessment;
monitoring of pesticides, preservatives, and other harmful compounds in a food product (e.g., milk produced from cattle in a dairy operation, or in food to be consumed by humans);
measurement or monitoring of stress indicators;
allergy testing or detection of allergens;
detection or screening for ear infection;
cardiovascular/respiratory health (including pre-heart attack detection, post heart attack detection/monitoring, overall heart health, oxygenation monitoring, pulse, heart dysrythmia alert, respirations, stroke detection, pneumonia detector, respiratory differential, sleep apnea detection);
detection of influenza or other diseases with methods including lateral flow analysis, diffraction-based methods, electrochemical detection;
musculoskeletal testing (muscle performance, osteoporosis, body fat);
monitoring health factors in neonates, such as bilirubin levels for jaundice detection; and
monitoring blood sugar levels for diabetics.

As used herein, the term “analyte” means an atom, ion, molecule, macromolecule, organelle, or cell, or, optionally, a mixture thereof, that is detected and measured. The term “analyte” also means a substance in a medium including, but not limited to molecules such as proteins, glycoproteins, antibodies, antigens, hemoglobin, enzymes, target molecules that bind to or react with specific enzymes or other proteins, metal salts, ions (e.g., hydrogen ions, hydroxy ions, sulfates, sulfonates, phosphates, nitrates, nitrites, or electrolytes, such as sodium potassium, lithium, or calcium ions), fatty acids, neurotransmitters, hormones, growth factors, cytokines, monokines, lymphokines, lipocalins, nutrients, sugars, receptors, nucleic acids, fragments of DNA or RNA, and pharmaceutical agents or derivatives or metabolites thereof. The term “analyte” also means structured elements such as macromolecular structures, organelles and cells, including, but not limited to cells of ectodermal, mesodermal, and endodermal origin such as stem cells, blood cells, neural cells, immune cells, and gastrointestinal cells, and also microorganisms, such as fungi, viruses, bacteria and protozoa, or characteristic compounds produced by the same. For example, in pH measurement, the analyte can be hydrogen ions and/or hydroxy ions. Some analytes indicate a possible disease condition by either a higher or lower than normal level.

An absorbent article as used herein can be, for instance, a diaper, a training pant, an incontinence product, a feminine hygiene product, a medical garment, a bandage, a facial tissue, a swab, and the like.

The particular targeted body fluid may vary depending upon the particular type of absorbent article and the desired application. For instance, in one aspect, the absorbent article comprises a diaper, a training pant, or the like, and the targeted body fluid is urine and/or fecal content. The presence of such a body fluid may be apparent to a caregiver or individual or may be indicated by a sensor within or associated with the absorbent article. Alternatively, the sensor may be configured to indicate the presence of a metabolite that would indicate the presence of a diaper rash. For adult incontinence products and feminine hygiene products, on the other hand, the sensor may be configured to indicate the presence of a yeast or of a particular constituent in urine or menses, such as a polysaccharide.

In other aspects of the present disclosure, the targeted body fluid may be one or more of any body fluid or biological sample including blood or any of its components (plasma, serum, etc.), menses, mucous, sweat, tears, urine, feces, saliva, sputum, semen, uro-genital secretions, gastric washes, pericardial or peritoneal fluids or washes, a throat swab, pleural washes, ear wax, hair, skin cells, nails, mucous membranes, amniotic fluid, vaginal secretions or any other secretions from the body, spinal fluid, human breath, gas samples containing body odors, flatulence or other gases, any biological tissue or matter, or an extractive or suspension of any of these.

This disclosure relates to tools for tracking certain outputs of individuals who use absorbent products. Such tracking can aid the individual or a caregiver in determining, for example, the existence or progress of certain health conditions or the adequacy of breast feeding.

The tools of this disclosure will be explained initially using the situation of a breastfeeding baby as an illustrative example, but the tools may be equally applied to any other combination of the absorbent articles, body fluids, sensors, etc. described herein as will be apparent to those of skill in the art. The tools of this disclosure are typically for use in situations for which multiple readings or occurrences can be tracked.

Mothers of newborn babies have a strong need to know how much breast milk their baby has consumed. There were 4.1 million births in the United States alone in 2003 and about 70% of all new moms breast feed. The first two weeks of breast feeding show the largest declines in breast feeding with 10% drop off each week. There is a significant opportunity to reassure mothers (especially first-time mothers) that their babies are breast feeding appropriately, particularly during the first weeks when mom is unsure and not confident in her breast feeding ability. The mother does not know the state of her baby's fluid intake and may question her baby's level of hydration.

In one aspect, the tools described herein may be an integral part of reassuring a nursing mother that her baby is receiving sufficient breast milk and therefore sufficient nutrition. The tools use objective recordkeeping indicative of the amount of breast milk swallowed by the baby. In another aspect, the tools described herein may be an integral part of reassuring a caregiver or an individual that the individual is receiving sufficient health care with respect to a potential or actual health condition.

For the purposes of this disclosure, “mother” is defined as the person who is breastfeeding a baby, whether that person is or is not the actual birth mother. “Mother” may also refer to a caregiver, male or female, who is monitoring a health condition in an individual. Similarly, the term “individual” may also refer to a subject of any age who is monitoring a health condition.

Various methods can be used to characterize the health condition or breastfeeding volume of interest. For example, because breastfeeding volume is difficult to measure directly, the amount of breast milk as an input may be inferred from the amount of urinary and fecal output of the baby, such as from a regular or random sampling of the volume of urinary and fecal output retained in a diaper or other article worn by the incontinent baby. Typically, the dry and wet weights of a diaper may be compared to estimate the volume of urine retained in the diaper, which may then be related back to the breast milk intake. In most cases, however, sufficient breastfeeding volume may be inferred by simply counting the number of wet and bowel-movement-filled diapers each day. As long as the total for each day is above a standard minimum usually based on age, then the baby is deemed to have received a sufficient volume of breast milk.

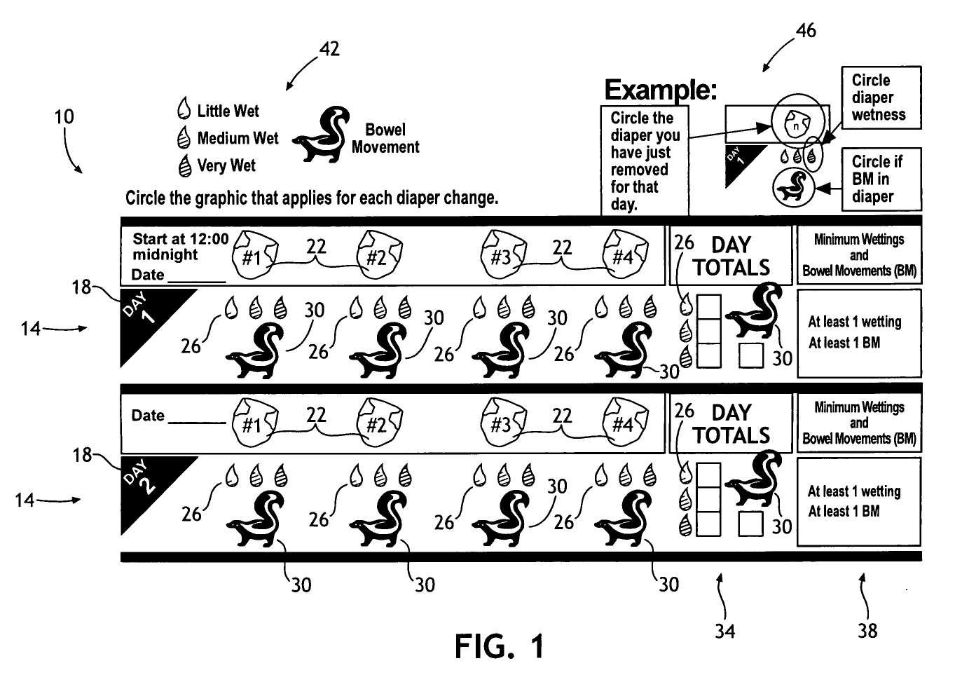

An exemplary tool 10 is shown in FIG. 1 using the situation of a breastfeeding baby as an illustrative example. This tool 10 tracks breastfeeding by tracking absorbent article use. The tool 10 divides absorbent article use by day 14 as indicated by headings 18 such as “DAY 1” in the leftmost column. Although limited to two days 14 in FIG. 1, the tool 10 can be expanded to cover any number of days, or the tool 10 may be further limited to one day.

The absorbent articles to be used each day 14 are represented by an absorbent article graphical representation 22, in this case a graphical representation of a diaper. The graphical representations described in this disclosure may be of any type including alphanumeric characters, or may be limited to non-alphanumeric graphic representations. Each absorbent article graphical representation 22 is also assigned by an ordinal number to indicate which absorbent article of the day 14 is being considered. Although limited to four absorbent articles per day 14 in FIG. 1, the tool 10 can be expanded to cover any number of absorbent articles per day 14, or the tool 10 may be further limited to one or more absorbent articles per day 14.

The tool 10 further includes, associated with each absorbent article, an absorbent article wetness graphical representation 26. In the tool 10 illustrated in FIG. 1, wetness for each absorbent article is represented by a series of three water droplets. Although limited to three droplets per absorbent article in FIG. 1, the tool 10 can be expanded to cover any number of absorbent article wetness graphical representations 26, or the tool 10 may be further limited to one absorbent article wetness graphical representation 26 per absorbent article.

For the aspects in which there is more than one absorbent article wetness graphical representation 26 per absorbent article, the absorbent article wetness graphical representations 26 may be differentiated to represent varying levels of absorbent article wetness. In the example shown in FIG. 1, the first water droplet is mostly unfilled indicating a low level of absorbent article wetness. The second water droplet is more filled or partially shaded representing a medium level of absorbent article wetness. The third water droplet is mostly filled or more darkly shaded indicating a high level of absorbent article wetness. In other aspects of the disclosure, the more than one absorbent article wetness graphical representations 26 may be differentiated by color, shape, darkness, size, or any other feature that may differentiate the absorbent article wetness graphical representations 26 indicating varying levels of absorbent article wetness.

The tool 10 as illustrated in the FIG. 1 example further includes, associated with each absorbent article, a fecal content graphical representation 30 of whether the absorbent article includes a bowel movement or fecal content. In the tool 10 illustrated in FIG. 1, fecal content for each absorbent article is represented by a skunk, indicative of the odor associated with the fecal content of the absorbent article. Although limited to one fecal content graphical representation 30 per absorbent article in FIG. 1, the tool 10 can be expanded to cover any number of fecal content graphical representations 30. In other aspects of the present disclosure, the fecal content graphical representation 30 may be an animated character holding its nose or any other graphical representation that indicates the smell or appearance of an absorbent article with fecal content.

For the aspects in which there is more than one fecal content graphical representation 30 per absorbent article, the fecal content graphical representations 30 may be differentiated to represent varying levels, consistency, color, etc. of absorbent article fecal content. In other aspects of the disclosure, the more than one fecal content graphical representations 30 may be differentiated by color, shape, darkness, size, or any other feature that may differentiate the fecal content graphical representations 30 indicating varying levels, consistency, color, etc. of absorbent article fecal content.

To increase understanding on the part of the user of the tool 10, the graphical representation(s) can be thematically related to the indication, feature, or health condition the graphical representation is representing. In the example of FIG. 1, indication of absorbent article wetness is graphically represented by a series of water droplets, and indication of absorbent article fecal content is graphically represented by a skunk because of odor.

The tool 10 further includes, for each day, an assessment section 34 in which the user of the tool 10 can total and record the data recorded over the course of that day. Such totals can include the number of wet absorbent articles recorded over the course of the day, and the number of absorbent articles with fecal content recorded over the course of the day. For the example illustrated in FIG. 1, the total number of absorbent articles including fecal content recorded over the course of the day is totaled and entered in the appropriate space in the assessment section 34. In this example, the total space for the fecal content absorbent articles is marked with the same fecal content graphical representation 30 used with each absorbent article over the course of the day. In addition, the total number of absorbent articles including wetness recorded over the course of the day is totaled and entered in the appropriate space in the assessment section 34. In this example, the total space for the wet absorbent articles is marked with the same wetness graphical representations 26 used with each absorbent article over the course of the day. The total number of wet absorbent articles at each level of wetness are each recorded in the appropriate space in the assessment section 34.

The tool 10 further includes, for each day, an information section 38 in which information is presented indicating the expected minimum totals for each day as a guide to the caregiver or individual with respect to what one might typically expect under the conditions of the tool's use. Such expected minimum totals can be based on the age of the subject or other factors. For the example illustrated in FIG. 1, the expected minimum total number of wet absorbent articles and the expected minimum total number of absorbent articles including fecal content, is presented for each day of infant's life. The tool 10 can also include instructions for the caregiver or individual with respect to how to respond if any particular expected minimum total is not equaled or exceeded.

The tool 10 can further include a key 42 indicating the meaning of each graphical representation. Although the graphical representations are typically selected to be intuitively obvious to the user of the tool 10, some indicators or conditions may not lend themselves to be easily graphically represented, at least to an initial or casual observer. In addition, the user of the tool 10 might be sleep-deprived or incapacitated in some manner and might not immediately relate the graphical representation to the item being represented. In one example, the absorbent articles associated with the tool 10 can include a bilirubin sensor to indicate the presence or level of jaundice in a newborn baby. An obvious graphical representation of bilirubin might not be immediately apparent; a capital B or a yellow circle could be used but would not necessarily indicate bilirubin to the average user. In this case, a key 42 translating the capital B or yellow circle to a bilirubin/jaundice indication would be very helpful to the user. Once the association is understood by the user, the user would likely not need to consult the key 42 with every use of the tool 10.

The tool 10 can further include an example 46 demonstrating the use of the tool 10. Although the graphical representations are typically selected to make use of the tool 10 intuitively obvious, the user, especially if an initial or casual observer, might benefit from an example 46. In addition, the user of the tool 10 might be sleep-deprived or incapacitated in some manner and might not immediately relate the graphical representations to the items being represented.

Understanding and ease of use of the tool 10 can be further enhanced by associating the absorbent article more closely with the graphical representations of the tool 10. For example, an absorbent article may include a wetness indicator of any suitable type. The user of the tool 10, upon observing a positive indication of wetness provided by the wetness indicator associated with the absorbent article, can easily record that wetness on the tool 10.

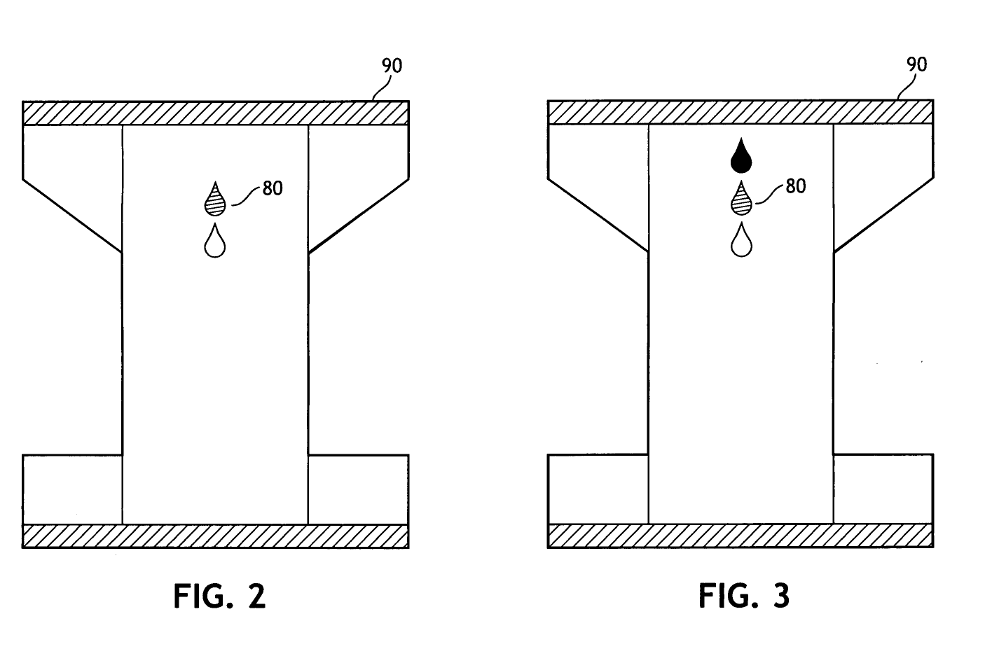

To further enhance use of the tool 10, the same graphical representation used to indicate wetness in the tool 10 can be used on the absorbent article as well. In the exemplary illustration of FIG. 2, for example, the wetness indicator 80 on an absorbent article 90 may be an image of a water droplet that appears when the absorbent article is insulted with urine. The user of the tool 10, upon observing the appearance of the water droplet on the absorbent article 90, can easily mark the water droplet on the tool 10 as a graphical representation of wetness.

To enhance use of the tool 10 even further, more than one graphical representation indicating wetness in the absorbent article 90 may appear on both the absorbent article 90 and on the tool 10. In the exemplary illustrations of FIGS. 2 and 3, for example, the absorbent article 90 may include a wetness indicator 80 in which three water droplets of varying designs appear as the level of wetness in the absorbent article increases. The same three water droplets of varying designs can also be shown on the tool 10 in association with that absorbent article 90. The user then records on the tool 10 the same number or type of water droplet(s) that appear on the absorbent article 90.

Relating the graphical representations from the absorbent article 90 shown in FIG. 2 to the tool 10, the absorbent article 90 of FIG. 2 shows two water droplets. The caregiver or wearer then circles the droplets shown for that absorbent article 90 on the tool 10. Using the key 42, the two droplets indicate a medium level of wetness. Relating the graphical representations from the absorbent article 90 shown in FIG. 3 to the tool 10, the absorbent article 90 of FIG. 3 shows three water droplets. The caregiver or wearer then circles the droplets shown for that absorbent article 90 on the tool 10. Using the key 42, the three droplets indicate a very wet absorbent article 90.

Again, it should be noted that the water droplet and wetness scenario is merely one example of use of such a tool in conjunction with an absorbent article. A tool of similar design could be used in which any particular graphical representation is used on the tool and on an absorbent article to enhance the use of the tool.

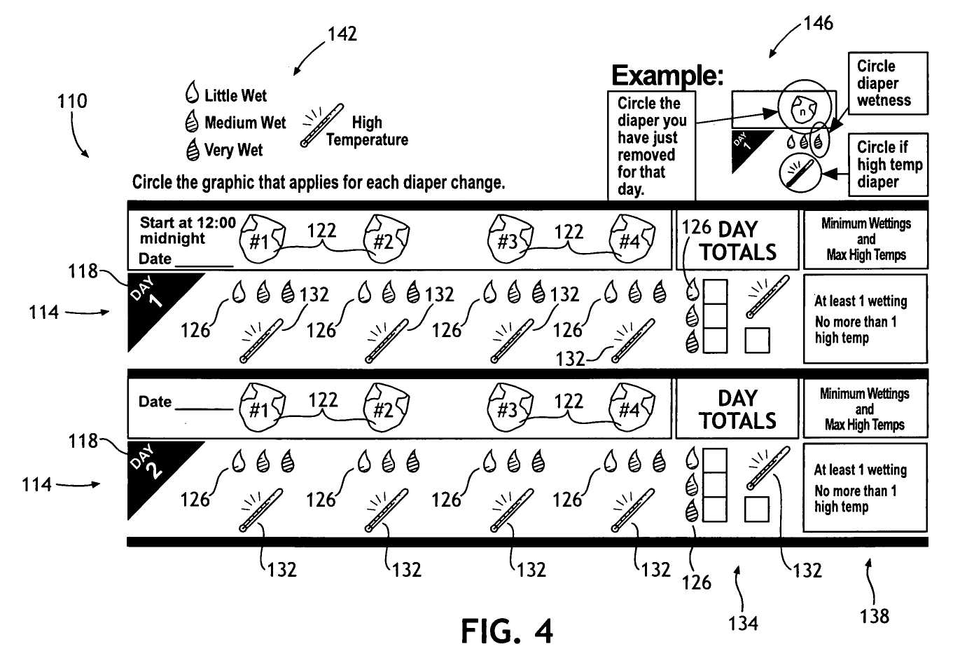

In a more general sense, the tools described herein track a health condition in the user or subject of use of an absorbent article. An example of this is illustrated in FIG. 4. The tool 110 divides absorbent article use by day 114 as indicated by headings 118 such as “DAY 1” in the leftmost column. Although limited to two days 114 in FIG. 4, the tool 110 can be expanded to cover any number of days, or the tool 110 may be further limited to one day.

The absorbent articles to be used each day 114 are represented by an absorbent article graphical representation 122, in this case a graphical representation of a diaper. The graphical representations described in this disclosure may be of any type including alphanumeric characters, or may be limited to non-alphanumeric graphic representations. Each absorbent article graphical representation 122 is also assigned by an ordinal number to indicate which absorbent article of the day 114 is being considered. Although limited to four absorbent articles per day 114 in FIG. 4, the tool 110 can be expanded to cover any number of absorbent articles per day 114, or the tool 110 may be further limited to one or more absorbent articles per day 114.

The tool 110 further includes, associated with each absorbent article, an absorbent article wetness graphical representation 126. In the tool 110 illustrated in FIG. 4, wetness for each absorbent article is represented by a series of three water droplets. Although limited to three droplets per absorbent article in FIG. 4, the tool 110 can be expanded to cover any number of absorbent article wetness graphical representations 126, or the tool 110 may be further limited to one absorbent article wetness graphical representation 126 per absorbent article.

For the aspects in which there is more than one absorbent article wetness graphical representation 126 per absorbent article, the absorbent article wetness graphical representations 126 may be differentiated to represent varying levels of absorbent article wetness. In the example shown in FIG. 4, the first water droplet is mostly unfilled indicating a low level of absorbent article wetness. The second water droplet is more filled representing a medium level of absorbent article wetness. The third water droplet is mostly filled indicating a high level of absorbent article wetness. In other aspects of the disclosure, the more than one absorbent article wetness graphical representations 126 may be differentiated by color, shape, darkness, size, or any other feature that may differentiate the absorbent article wetness graphical representations 126 indicating varying levels of absorbent article wetness.

The tool 110 as illustrated in the FIG. 4 example further includes, associated with each absorbent article, a health condition graphical representation 132 indicating the presence or level of a certain health condition. In the tool 110 illustrated in FIG. 2, the wearer's high temperature or fever is represented by a thermometer. Although limited to one health condition graphical representation 132 per absorbent article in FIG. 4, the tool 110 can be expanded to cover any number of health condition graphical representations 132. In other aspects of the present disclosure, the health condition graphical representation 132 may be any other graphical representation that indicates the presence or level of the health condition of concern.

The tool 110 may also include, associated with each absorbent article, graphical representations of second and/or further health conditions as sensed by the absorbent article.

For the aspects in which there is more than one health condition graphical representation 132 per absorbent article, the health condition graphical representations 132 may be differentiated to represent varying levels or other factors. In other aspects of the disclosure, the more than one health condition graphical representations 132 may be differentiated by color, shape, darkness, size, or any other feature that may differentiate the health condition graphical representations 132 indicating varying levels or other factors.

To increase understanding on the part of the user of the tool 110, the graphical representation(s) can be thematically related to the indication, feature, or health condition the graphical representation is representing. In the example of FIG. 4, indication of absorbent article wetness is graphically represented by a series of water droplets, and indication of the wearer's temperature is graphically represented by a thermometer.

The tool 110 further includes, for each day, an assessment section 134 in which the user of the tool 110 can total and record the data recorded over the course of that day. Such totals can include the number of wet absorbent articles recorded over the course of the day, and the number of instances above a certain temperature recorded over the course of the day. For the example illustrated in FIG. 2, the total number of instances above a certain temperature recorded over the course of the day is totaled and entered in the appropriate space in the assessment section 134. In this example, the total space for high temperature is marked with the same health condition graphical representation 132 used with each absorbent article over the course of the day. In addition, the total number of absorbent articles including wetness recorded over the course of the day is totaled and entered in the appropriate space in the assessment section 134. In this example, the total space for the wet absorbent articles is marked with the same wetness graphical representations 126 used with each absorbent article over the course of the day. The total number of wet absorbent articles at each level of wetness are each recorded in the appropriate space in the assessment section 134.

The tool 110 further includes, for each day, an information section 138 in which information is presented indicating the expected health condition assessment for each day as a guide to the caregiver or individual with respect to what one might typically expect under the conditions of the tool's use. Such expected health condition assessment can be based on the age of the subject or other factors. For the example illustrated in FIG. 4, the expected minimum total number of wet absorbent articles and the expected maximum total number of high temperature readings for each day is presented. The tool 110 can also include instructions for the caregiver or individual with respect to how to respond if any particular expected health condition assessment is not met.

The tool 110 can further include a key 142 indicating the meaning of each graphical representation. Although the graphical representations are typically selected to be intuitively obvious to the user of the tool 110, some indicators or conditions may not lend themselves to be easily graphically represented, at least to an initial or casual observer. In addition, the user of the tool 110 might be sleep-deprived or incapacitated in some manner and might not immediately relate the graphical representation to the item being represented. Once the association is made in the user, the user would likely not need to consult the key 142 with every use of the tool 110.

The tool 110 can further include an example 146 demonstrating the use of the tool 10. Although the graphical representations are typically selected to make use of the tool 10 intuitively obvious, the user, especially if an initial or casual observer, might benefit from an example 146. In addition, the user of the tool 110 might be sleep-deprived or incapacitated in some manner and might not immediately relate the graphical representations to the items being represented.

Understanding and ease of use of the tool 110 can be further enhanced by associating the absorbent article more closely with the graphical representations of the tool 110. For example, the absorbent article may include a wetness indicator of any suitable type. The user of the tool 110, upon observing a positive indication of wetness provided by the wetness indicator associated with the absorbent article, can easily record that wetness on the tool 110.

To further enhance use of the tool 110, the same graphical representation used to indicate wetness in the tool 110 can be used on the absorbent article as well, as described above with reference to FIGS. 1-3. For example, the wetness indicator on the absorbent article may be an image of a water droplet that appears when the absorbent article is insulted with urine. The user of the tool 110, upon observing the appearance of the water droplet on the absorbent article, can easily mark the water droplet on the tool 110 as a graphical representation of wetness.

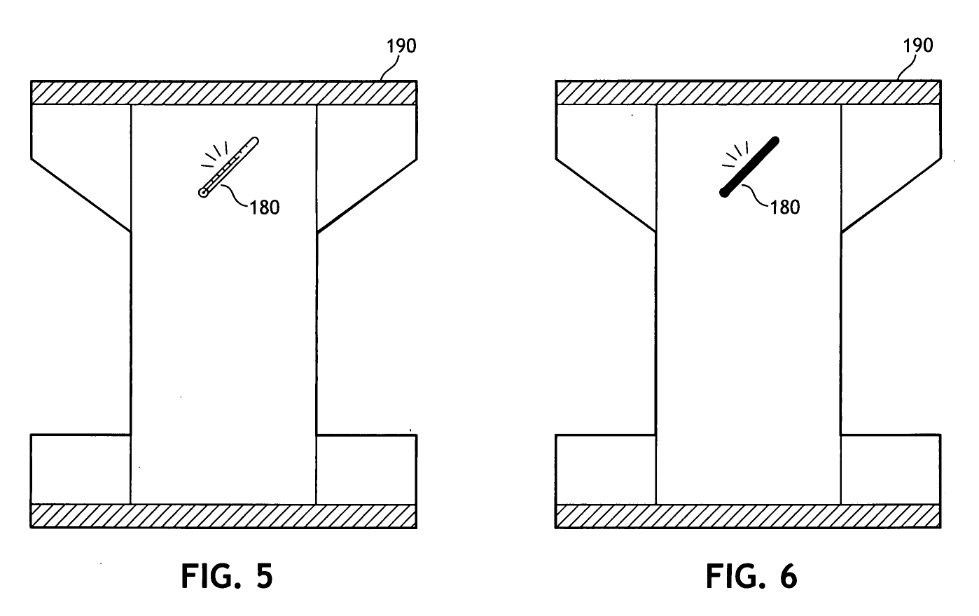

In addition, the same graphical representation used to indicate a health condition in the tool 110 can be used on the absorbent article as well. In the exemplary illustration of FIG. 5, for example, a health condition indicator 180 on an absorbent article 190 may be a thermometer that appears when a high temperature is sensed. The user of the tool 110, upon observing the appearance of the thermometer on the absorbent article 190, can easily mark the thermometer on the tool 110 as a graphical representation of the health condition.

In another aspect of the present invention, shown in the exemplary illustration of FIG. 6, for example, a health condition indicator 180 on an absorbent article 190 may be a thermometer that is shown in outline before the absorbent article 190 is donned by the wearer (as it appears in FIG. 5), but that is filled in, shaded, colored, or otherwise changes in appearance when a high temperature is sensed. The user of the tool 110, upon observing the change in appearance of the thermometer on the absorbent article 190, can easily mark the thermometer on the tool 110 as a graphical representation of the health condition.

Relating the graphical representations from the absorbent article 190 shown in FIG. 5 to the tool 110, the absorbent article 90 of FIG. 5 shows an outline of a thermometer. The caregiver or wearer observes the appearance of the thermometer and then circles the thermometer shown for that absorbent article 190 on the tool 110. Using the key 142, the thermometer indicates the presence of a high temperature. Relating the graphical representations from the absorbent article 190 shown in FIG. 6 to the tool 110, the absorbent article 190 of FIG. 6 shows a shaded thermometer. The caregiver or wearer observes the change in appearance of the thermometer and then circles the thermometer shown for that absorbent article 190 on the tool 110. Using the key 142, the thermometer indicates the presence of a high temperature.

To enhance the use of the tool 110 even further, more than one graphical representation indicating wetness in the absorbent article may appear on both the absorbent article and on the tool 110. For example, the absorbent article may include a wetness indicator in which three water droplets of varying designs appear as the level of wetness in the absorbent article increases. The same three water droplets of varying designs can also be shown on the tool 110 in association with that absorbent article. The user then records on the tool 110 the same number or type of water droplet(s) that appear on the absorbent article.

Again, it should be noted that the water droplet and wetness scenario and the thermometer scenario are merely examples of use of such a tool in conjunction with an absorbent article. A tool of similar design can be used in which any particular graphical representation is used on the tool and on an absorbent article to enhance the use of the tool.

The tool 110 can also include space to enter further information that may be relevant to the health condition, to a related health condition, or to anything associated with the user or caregiver. For example, the tool 110 might be used to record the wet absorbent articles of an institutionalized adult patient. The tool 110 can also include space to record medications administered to the patient.

In one aspect of the present disclosure, the tool 10, 110 may be included in a package of absorbent articles including the tool 10, 110 and instructions for using the tool 10, 110 as described herein. The term “instructions” referred to herein is an outline or manual of technical procedure for the use of the tool 10, 110. Instructions can also include tips or information related to the use of the absorbent articles, to the user or caregiver, or to the health conditions covered by the tool 10, 110. In general, the instructions may describe the use of the tool 10, 110 for any of the steps for which it can be used. The instructions can also outline the potential actions, reactions, and/or demeanor to be exhibited by a subject or user.

The descriptive nature of the instructions can be provided by text, by figures or diagrams, or by any other visual guide, such as by the sequential numbering of operations in correspondence with an effective sequence of steps for using the tool. Graphical representations such as those described herein can also be included in the instructions. Also, the instructions and/or the tool 10, 110 may be included with the package in any of several forms. For example, the instructions and/or tool 10, 110 may be printed on the outside or the inside of the package itself, or may be in the form of a sheet or card contained inside the package or attached to the package. In general, the instructions may be provided in any form in which the functional relationship between the instructions and the use of the tool 10, 110 is clear to the user.

These and other modifications and variations to the present disclosure may be practiced by those of ordinary skill in the art, without departing from the spirit and scope of the present disclosure, which is more particularly set forth in the appended claims. In addition, it should be understood that aspects of the various aspects may be interchanged both in whole and in part. Furthermore, those of ordinary skill in the art will appreciate that the foregoing description is by way of example only, and is not intended to limit the disclosure so further described in such appended claims.

What is claimed:

1. A recording tool for tracking absorbent article use, the tool comprising:
an ordinal number for each absorbent article for a given day;
associated with each absorbent article, a non-alphanumeric health condition graphical representation of whether the absorbent article indicates the health condition, wherein the health condition graphical representation is thematically related to the health condition; and
associated with the given day, a health condition assessment summarizing the absorbent articles indicating the health condition.

2. The recording tool of claim 1, wherein the health condition is wetness.

3. The recording tool of claim 2, further comprising information regarding a minimum expected wetness total indication associated with the given day.

4. The recording tool of claim 3, further comprising instructions with respect to how to respond when the health condition assessment does not equal or exceed the minimum expected wetness total indication.

5. The recording tool of claim 2, further comprising, associated with each absorbent article, a fecal content graphical representation of whether the absorbent article includes fecal content, wherein the fecal content graphical representation is thematically related to the fecal content.

6. The recording tool of claim 5, further comprising, associated with the given day, a fecal content total indication of the total number of absorbent articles including fecal content.

7. The recording tool of claim 6, wherein the fecal content total indication includes the fecal content graphical representation.

8. The recording tool of claim 6, further comprising information regarding a minimum expected fecal content total indication associated with the given day.

9. The recording tool of claim 8, further comprising instructions with respect to how to respond when the fecal content total indication does not equal or exceed the minimum expected fecal content total indication.

10. The recording tool of claim 9, further comprising a plurality of fecal content graphical representations and a fecal content total indication for each of a plurality of days.

11. The recording tool of claim 5, wherein the fecal content graphical representation is thematically related to the fecal content by indicating that odor is associated with fecal content.

12. The recording tool of claim 2, further comprising a plurality of wetness graphical representations and a health condition assessment for each of a plurality of days.

13. The recording tool of claim 2, wherein the wetness graphical representation includes a plurality of depictions indicating a wetness level.

14. The recording tool of claim 13, wherein the depictions are of increasing size or darkness to indicate increasing wetness levels.

15. The recording tool of claim 2, wherein the health condition assessment includes a plurality of depictions indicating a wetness level, and wherein the depictions are of increasing size or darkness to indicate increasing wetness levels.

16. The recording tool of claim 1, further comprising a key explaining the meaning of the health condition graphical representation.

17. The recording tool of claim 1, further comprising an example illustrating how to use the recording tool.

18. The recording tool of claim 1, wherein the health condition assessment includes the health condition graphical representation.

19. The recording tool of claim 1, further comprising an absorbent article graphical representation of each absorbent article for the given day.

20. The recording tool of claim 1, wherein the recording tool is adapted to be used to track breastfeeding.

21. The recording tool of claim 1, wherein the recording tool is adapted to be used to track a subject's health.

22. The recording tool of claim 1, further comprising information regarding an expected health condition assessment associated with the given day.

23. The recording tool of claim 22, further comprising instructions with respect to how to respond when the health condition assessment does not meet the expected health condition assessment.

24. The recording tool of claim 1, further comprising a plurality of health condition graphical representations and a health condition assessment for each of a plurality of days.

25. The recording tool of claim 1, the absorbent article comprising the health condition graphical representation.

26. A recording tool for tracking absorbent article use, the tool comprising:
an ordinal number for each absorbent article for a given day;
associated with each absorbent article, a wetness graphical representation of whether the absorbent article includes wetness, wherein the wetness graphical representation is thematically related to the wetness;
associated with each absorbent article, a fecal content graphical representation of whether the absorbent article includes fecal content, wherein the fecal content graphical representation is thematically related to the fecal content;
associated with the given day, a wetness total indication totaling the number of absorbent articles including wetness and a fecal content total indication of the total number of absorbent articles including fecal content.

27. A recording tool for tracking absorbent article use, the tool comprising:
an ordinal number for each absorbent article for each of a plurality of days;
associated with each absorbent article, a wetness graphical representation of whether the absorbent article includes wetness, wherein the wetness graphical representation is thematically related to the wetness;
associated with each absorbent article, a fecal content graphical representation of whether the absorbent article includes fecal content, wherein the fecal content graphical representation is thematically related to the fecal content;
associated with each of the plurality of days, a wetness total indication totaling the number of absorbent articles including wetness and a fecal content total indication of the total number of absorbent articles including fecal content, wherein the wetness total indication includes the wetness graphical representation, and wherein the fecal content total indication includes the fecal content graphical representation.
